(19) United States
(12) Patent Application Publication
(10) Pub. No.: US 2013/0123388 A1
(43) Pub. Date: May 16, 2013

(54) Fiber-Reinforced Thermoplastic Resin Composition and Process for Producing Fiber-Reinforced Thermoplastic Resin Composition

(71) Applicants: Hideo Kurihara, Tokyo (JP); Masashi Yamaguchi, Tokyo (JP); Noriaki Tsukuda, Tokyo (JP)

(72) Inventors: Hideo Kurihara, Tokyo (JP); Masashi Yamaguchi, Tokyo (JP); Noriaki Tsukuda, Tokyo (JP)

(73) Assignee: Daimaru Sangyo Co., Ltd., Tokyo (JP)

(21) Appl. No.: 13/810,101

(22) PCT Filed: Jul. 13, 2011
(86) PCT No.: PCT/JP2011/065949

§ 371 Date: Jan. 14, 2013

(30) Foreign Application Priority Data
Jul. 26, 2010 (JP) 2010-166891

(51) Int. Cl. C08L 77/00; C08L 7/00; C08L 23/12; C08L 9/02; C08L 23/06; C08L 9/00

(52) U.S. Cl. CPC C08L 77/00; C08L 23/06; C08L 9/00; C08L 23/12; C08L 9/02; C08L 7/00
USPC 523/223; 524/493

(57) ABSTRACT

Provided are a fiber-reinforced thermoplastic resin composition excellent in terms of dispersion property, moldability, rigidity, and reinforcing property and a process for producing the resin composition. This fiber-reinforced thermoplastic resin composition comprises (a) a polyolefin, (b) a rubbery polymer, (c) spherical silica having a water content of 1,000 ppm or less, (d) ultrafine fibers of a thermoplastic polymer having amide groups in the main chain, and (e) a silane coupling agent, wherein the ingredient (d) has been dispersed as ultrafine fibers having an average diameter of 1 [mu]m or less in a matrix comprising the ingredients (a), (b), and (c), and the ingredients (a), (b), (c), and (d) have been chemically bonded through the ingredient (e).

### RELATED APPLICATION INFORMATION

This application is a National Stage of Application PCT/JP2011/065949, filed Jul. 13, 2011, which claims priority to Japanese Patent Application No. JP 2010-166891, filed Jul. 26, 2010, which are incorporated herein by reference.

### TECHNICAL FIELD

The present invention relates to a fiber-reinforced thermoplastic resin composition of a thermoplastic polymer having amide groups in the main chain in a matrix comprising rubber, polyolefin and silica, and a production process thereof.

### BACKGROUND ART

In order to raise the modulus of elasticity and strength of rubber and resins, the blending of chopped fibers such as of cellulose fibers into carbon fibers, glass fibers, or high elasticity organic fibers, e.g., aromatic polyamide, has been widely employed. However, the fields of industrial applicability have been limited to specific fields due to adequate performance not always having been realized from problems in the dispersibility of fibers and chemical bonding between fiber-matrix, and productivity of molded articles having been inferior from workability problems, and thus the appearance has been inferior.

In Patent Document 1, Patent Document 2 and Non-patent Document 1, compositions have been disclosed in which ultrafine nylon fibers have been formed using a technique of in situ fiber formation with polyolefin and rubbery polymer as the matrix.

By blending this composition into rubbers, resins or the like, it is possible to obtain fine fiber reinforced composites having superior mechanical properties.

The series of fine fiber reinforced composites is already being employed in automotive components, industrial materials, etc.
Patent Document 1: Japanese Unexamined Patent Application, Publication No. H7-238189
Patent Document 2: Japanese Unexamined Patent Application, Publication No. H9-59431
Non-patent Document 1: The Society of Rheology, Japan, vol. 25, No. pp. 275-282 (1997)

### DISCLOSURE OF THE INVENTION

### Problems to be Solved by the Invention

However, accompanying performance improvements in automotive components, industrial materials, etc. in recent years, the high output of materials and further performance improvements in high elasticity such as high stress, and durability are being demanded.

In contrast, in fine fiber-reinforced composites according to the aforementioned conventional technology, there has been trouble in the inferiority in moldability, rigidity, and reinforcement in strength.

Therefore, the present invention solves the aforementioned problems, and has an object of providing a fiber-reinforced thermoplastic resin composition superior in dispersibility, moldability, rigidity, and strength reinforcing property, and a process for producing the same.

### Means for Solving the Problems

In order to achieve the above object, the present invention provides a fiber-reinforced thermoplastic resin composition including (a) 100 parts by weight of polyolefin; (b) 10 to 600 parts by weight of rubbery polymer having a glass transition temperature no higher than 0° C.; (c) 10 to 500 parts by weight of spherical silica having an average particle size of no more than 1 μm and a water content of no more than 1000 ppm; (d) 1 to 40 parts by weight of ultrafine fibers of a thermoplastic polymer having amide groups in the main chain; and (e) 0.1 to 20 parts by weight of a silane coupling agent, in which component (d) is dispersed as ultrafine fibers having an average diameter of no more than 1 μm in a matrix comprising component (a), component (b) and component (c), and each component among (a), component (b), component (c) and component (d) makes a chemical bond via component (e); and a process for producing the same.

### Effects of the Invention

A fiber-reinforced thermoplastic resin composition in which a fiber diameter of thermoplastic polymer having amide groups in the main chain dispersed in fiber form in a matrix composed of rubber, polyolefin and spherical silica is no more than 1 μm, can be provided as a fiber-reinforced thermoplastic resin composition superior in terms of improvement in dispersibility, improvement in moldability, abrasion resistance and reinforcement property improving mechanical characteristics.

This fiber-reinforced thermoplastic resin composition superior in reinforcement property makes it possible to improve mechanical properties of high rigidity and modulus of elasticity by adding as a reinforcing material to rubber or resin, whereby molding and workability are also improved, and makes so that an improvement in the productivity of molded articles or an article having favorable appearance can be obtained, and thus can be used in industrial application fields such as automotive components and industrial materials.

### BRIEF DESCRIPTION OF THE DRAWINGS

FIG. 1 is a scanning electron microscope (SEM) photograph for a fiber-reinforce thermoplastic resin composition of Example 1;

FIG. 2 is a scanning electron microscope (SEM) photograph for a fiber-reinforced thermoplastic resin composition of Comparative Example 1;

FIG. 3 is a scanning electron microscope (SEM) photograph for a fiber-reinforced thermoplastic resin composition of Comparative Example 2;

FIG. 4 is a transmission electron microscope (TEM) photograph for a fiber-reinforced thermoplastic resin composition of Example 1; and

FIG. 5 is a transmission electron microscope (TEM) photograph for a fiber-reinforced thermoplastic resin composition of Comparative Example 1.

### EXPLANATION OF REFERENCE NUMERALS

1 nylon
3 silica
5 polyethylene
7 EPDM

### PREFERRED MODE FOR CARRYING OUT THE INVENTION

Hereinafter, a fiber-reinforced thermoplastic resin composition according to an embodiment of the present invention is a composition containing: (a) 100 parts by weight of polyolefin; (b) 10 to 600 parts by weight of a rubbery polymer having a glass transition temperature of no more than 0° C.; (c) 10 to 500 parts by weight of spherical silica having an average particle size of no more than 1 μm and water content of no more than 1000 ppm; (d) 1 to 400 parts by weight of ultrafine fibers of a thermoplastic polymer having amide groups in the main chain; and (e) 0.1 to 20 parts by weight of a silane coupling agent, in which an aspect ratio is at least 2 and no more than 1000, component (d) is dispersed as ultrafine fibers with an average diameter of no more than 1 μm in a matrix composed of component (a), component (b) and component (c), and each component among component (a), component (b), component (c) and component (d) make chemical bonds via component (e).

Component (a) is a polyolefin, and preferably has a melting point in the range of 70 to 250° C.

In addition, one having a Vicat softening temperature of at least 50° C., and particularly preferably 50 to 200° C., is used. As such a substance, a homopolymer or copolymer of olefins with a carbon number of 2 to 8; a copolymer of the olefin with a carbon number of 2 to 8 and an aromatic vinyl compound such as styrene or chlorostyrene and a-methylstyrene; a vinyl acetate copolymer with the olefin with a carbon number of 2 to 8; a copolymer of the olefin with a carbon number of 2 to 8 and acrylic acid or an ester thereof; and a copolymer of the olefin with a carbon number of 2 to 8 and a vinylsilane compound are preferably used.

As specific examples, there is high density polyethylene, linear low density polyethylene, low density polyethylene, polypropylene, ethylene-propylene block copolymer, ethylene-propylene random copolymer, ethylene-vinyl acetate copolymer, ethylene-vinyl alcohol copolymer, ethylene-acrylic acid copolymer, ethylene-methyl acrylate copolymer, ethylene-ethyl acrylate copolymer, ethylene-propyl acrylate copolymer, ethylene-butyl acrylate copolymer, ethylene-2-ethylhexyl acrylate copolymer, ethylene-hydroxyethyl acrylate copolymer, ethylene-vinylsilane copolymer, ethylene-styrene copolymer, propylene-styrene copolymer and the like.

Among these polyolefins of component (a), particularly preferable are high density polyethylene, linear low density polyethylene, low density polyethylene, polypropylene, ethylene-propylene block copolymer, ethylene-propylene random copolymer, ethylene-vinyl acetate copolymer, ethylene-vinyl alcohol copolymer, ethylene-acrylic acid copolymer, ethylene-methyl acrylate copolymer, and thereamong, those having a melt flow index in the range of 0.2 to 50 g/10 min are preferable, and only one type of these may be used, or two or more types may be combined.

Next, the rubbery polymer of component (b) having a glass transition temperature of no more than 0° C. will be explained. The glass transition temperature is no more than 0° C., and more preferably is no more than −20° C. As such a polymer, natural rubber, diene-based rubbers such as isoprene rubber, butadiene rubber, styrene-butadiene rubber, acrylonitrile-butadiene rubber, butyl rubber, chlorinated butyl rubber, brominated butyl rubber, nitrile-chloropyrene rubber, nitrile-isoprene rubber, acrylate-butadiene rubber, vinyl pyridine-butadiene rubber, vinylpyridine-styrene-butadiene rubber, styrene-chloroprene rubber, styrene-isoprene rubber, carboxylated styrene-butadiene rubber, carboxylated acrylonitrile-butadiene rubber, styrene-butadiene block copolymer, styrene-isoprene block copolymer, carboxylated styrene-butadiene block copolymer and carboxylated styrene-isoprene block copolymer; polyolefinic elastomers such as styrene-propylene rubber, ethylene-propylene-diene terpolymer, ethylene-butene rubber, ethylene-butene-diene terpolymer, chlorinated polyethylene, chlorosulfonated polyethylene and ethylene-vinyl acetate copolymer; rubbers having a polymethylene-type main chain such as acrylic rubber, ethylene-acrylic rubber, polychlorinated trifluorine ethylene, fluororubber, and hydrogenated nitrile-butadiene rubber; rubbers having oxygen atoms in the main chain such as epichlorohydrin copolymer, ethyleneoxide-epichlorohydrin-allylglycidylether copolymer and propyleneoxide-allylglycidylether copolymer; silicon rubbers such as polyphenylmethylsiloxane, polydimethylsiloxane, polymethylethylsiloxane and polymethylbutylsiloxane; rubbers having nitrogen atoms and oxygen atoms in addition to carbon atoms in the main chain such as nitroso rubbers, polyester urethane and polyether urethane; etc. can be exemplified. In addition, a polymer arrived at by these rubbers being denatured by an epoxy or the like, or one silane denatured, or maleinated are preferable.

For the silica of component (c) having an average particle size of no more than 1 μm and water content of no more than 1000 ppm, a process of producing microscopic spherical oxide particles employing the deflagration phenomenon of metal powders (Vaporized Metal Combustion Method) is preferable (hereinafter abbreviated as VMC method).

More specifically, it is silica produced by a process that makes ultrafine oxide particles by dispersing the metal powder in an airflow of oxygen, oxidizing by igniting, thereby making the metal and oxide into a vapor or liquid by the heat of reaction thereof, and then cooling.

The silicas produced from the VMC method are a group of silicas that are microscopic particle spheres of perfectly spherical form having an average particle size from 0.2 μm to 2.0 μm, and do not yield an aggregated structure of like silicas. In addition, that also having little moisture adsorption, characterized as no more than 1000 ppm, is used in the present embodiment.

The average particle size of silica produced from the VMC method used in the present embodiment is 1 μm, and more preferably 0.5 μm. As the water content, silica having a water content of no more than 1000 ppm is useful as a coupling agent, and the appropriate amount of component (c) used in the present invention is considered to realize functionality as a coupling agent. For example, the silanol group of component (c) has a function as a coupling agent, and easily reacts with the alkoxy group of component (e), or that which forms a structure of a silanol group from the alkoxy group via water in component (e). It also undergoes a condensation reaction with the amide group of component (d). As described, component (c) in the present invention effectively acts in the reaction.

In particular, component (c) is preferably jointly used with component (e), or used as a mixture of three components of component (e) and organic peroxide, or the like.

In addition, the silica possesses silanol groups, and in a dry method and VMC method in the production process, the silanol group concentration is no more than 10 μmol/m³, which is preferable in the present production. It is considered that excessive reaction will progress if the silanol group concentration is high.

The moisture amount in the silica is an important factor in the present embodiment, and no more than 1000 ppm is preferable as the moisture amount. In regards to the moisture amount of the silica particles, the total content including surface adhesion, crystallization water, etc. is preferably no more than 1000 ppm. It is more preferably no more than 800 ppm, and particularly preferably no more than 400 ppm.

If the water content of the silica exceeds 1000 ppm, in the step of adjusting the extrudate in which component (d) is melt kneaded by a temperature that is at least the melting point of both component (a) and component (d) into the matrix composed of component (a), component (b) and component (c), and then extrusion is performed (second step of the present invention), the amide group in the thermoplastic polymer having amide groups in the main chain of component (d) preferentially causes a hydrolysis reaction with the abundant water to form an organic acid with the amino group, thereby bringing about a decline in the melt viscosity due to the molecular weight of component (d) declining. Based on the principle of microphase separation upon conjugating, the viscosity balance ratio between the matrix component of component (a), component (b) and component (c) and (d) the thermoplastic polymer having amide groups in the main chain forming a domain, which is an important factor, is drastically collapsed, and the fiber diameter size becomes 1 μm or more or becomes a film of several tens of μm, and it is not possible to obtain a thermoplastic resin composition with a fiber diameter of no more than 1 μm and aspect ratio of at least 2 and no more than 1000. Alternatively, it becomes impossible to produce the thermoplastic resin composition. For example, even if obtained, it would be a thermoplastic resin composition for which the effect as a reinforcing material is remarkably inferior, which is not preferable.

No more than 1 μm is preferable for the average particle size of component (c). If the average particle size exceeds 1 μm, in the step of adjusting the extrudate (third step of the present invention), there becomes a tendency of foreign substances upon drawing and/or rolling, and it becomes impossible to form ultrafine fibers of the thermoplastic polymer having amide groups in the main chain of component (d), which is not preferable. In addition, even if fibers are obtained after drawing/rolling, they would not be preferable due to the aspect ratio increasing outside the range of at least 2 to no more than 1000.

In addition, with the morphology of silica being shapes other than spherical particles such as undefined shapes and agglomerates due to cohesion of silicas, when fibers are formed in the third step of drawing and/or rolling at a temperature lower than the melting temperature of component (d), it will be an unstable process, which is not preferable.

In addition to the VMC method, there is a wet precipitation method, wet gel method, dry method powder melting method and the like; however, with all processes other than the VMC method, the silica all tends to adsorb the moisture to reach a moisture amount exceeding 1000 ppm. In addition, even if using after drying to establish a moisture amount of no more than 1000 ppm, it will become an undefined shape due to cohesion of silicas. Although there is a strong trend for the silica obtained by the powder melting method not to form aggregates, silica having an average particle size exceeding 10 μm is often observed. In addition, the grain size distribution is wide, and there are also particles having a maximum particle size exceeding 50 μm, and since this is a foreign substance in the process during drawing/rolling in the third step and stable drawing/rolling will not be possible, this is not appropriate as an ultrafine fiber thermoplastic resin composition or in the production thereof.

For this reason, the silica of ultrafine oxide produced by the VMC method is preferable as the silica of component (c).

Next, the thermoplastic polymer (hereinafter abbreviated as polyamide) having amide groups in the main chain of component (d) will be explained.

That having a melting point of 130 to 350° C. is used, and further, it is higher than the melting point of the olefin of component (a), and is more preferably in the range of 160 to 265° C. As such a component (d), a polyamide yielding a strong fiber by extruding and rolling is preferable.

As specific examples of the polyamide, nylon 6, nylon 66, nylon 6-nylon 66 copolymer, nylon 610, nylon 612, nylon 46, nylon 11, nylon 12, nylon MXD6, polycondensate of xylylendiamine and adipic acid, polycondensate of xylylendiamine and pimelic acid, polycondensate of xylylendiamine and suberic acid, polycondensate of xylylendiamine and azelaic acid, polycondensate of xylylendiamine and terephthalic acid, polycondensate of octamethylenediamine and terephthalic acid, polycondensate of trimethylhexamethylenediamine and terephthalic acid, polycondensate of decamethylenediamine and terephthalic acid, polycondensate of undecamethylenediamine and terephthalic acid, polycondensate of dodecamethylenediamine and terephthalic acid, polycondensate of tetramethylenediamine and isophthalic acid, polycondensate of octamethylenediamine and isophthalic acid, polycondensate of trimethylhexamethylenediamine and isophthalic acid, polycondensate of decamethylenediamine and isophthalic acid, polycondensate of undecamethylenediamine and isophthalic acid, polycondensate of dodecamethylenediamine and isophthalic acid, and the like are exemplified.

As those particularly preferable among these polyamides, one, two or more polyamides selected from the group consisting of nylon 6, nylon 66, nylon 6-nylon 66 copolymer, nylon 610, nylon 612, nylon 46, nylon 11 and nylon 12 can be exemplified. These polyamides preferably have a molecular weight in the range of 10,000 to 200,000.

As the silane coupling agent of component (e) used in the present embodiment, vinyltrimethoxysilane, vinyltriethoxysilane, vinyl tris(β-methoxyethoxy)silane, vinyltriacetylsilane, γ-methacryloxypropyltrimethoxysilane, β-(3,4-epoxycyclohexyl)ethylmethoxysilane, γ-glucidoxypropyltrimethoxsilane, γ-glucidoxypropylmethyldimethoxysilane, γ-glucidoxypropylmethyldiethoxysilane, γ-glucidoxypropylethyldimethoxysilane, γ-glucidoxypropylethyldiethoxysilane, N-β-(aminoethyl)aminopropyltrimethoxysilane, N-β-(aminoethyl)aminopropyltriethoxysilane, N-β-(aminoethyl)aminopropylmethyldimethoxysilane, N-β-(aminoethyl)aminopropylethyldimethoxysilane, N-β-(aminoethyl)aminopropylethyldiethoxysilane, γ-aminopropyltriethoxysilane, N-phenyl-γ-aminopropyltrimethoxysilane, γ-(N-(β-methacryloxyethyl)-N,N-dimethylammonium(chloride))propylmethoxysilane, γ-mercaptopropyltrimethoxysilane, γ-mercaptopropyltriethoxysilane, stildiaminosilane and the like can be exemplified. Preferably, a silane coupling agent that tends to steal and detach a hydrogen atom from alkoxy groups, etc. and/or having a polar group and an amino group, mercapto group or vinyl group is suitable.

An organic peroxide can be jointly used along with component (e). As the organic peroxide, it is preferably one having a 1-minute half-life temperature that is the higher temperature of either the melting point of component (a) or the melting point of component (d), or in a temperature range about 20° C. higher than this temperature. More specifically, that having a 1-minute half-life temperature on the order of 80 to 270° C. is ideal.

As specific examples of the organic peroxide, 1,1-di-t-butylperoxy-3,3,5-trimethylcyclohexane; 1,1-di-t-butylperoxycyclohexane; 2,2-di-t-butylperoxybutane; 4,4-di-t-butylperoxy valerianic acid n-butyl ester; 2,2-bis(4,4-di-t-butylperoxycyclohexane)propane; 2,2,4-trimethylpentyl peroxyneodecanoate; 2,2,4-trimethylpentyl peroxyneodecanoate; α-cumyl peroxyneodecanoate; t-butyl peroxyneohexanoate; t-butyl peroxypivalate; t-butyl peroxyacetate; t-butyl peroxylaurate; t-butyl peroxybenzoate, t-butyl peroxyisophthalate, and the like can be exemplified. Thereamong, that having a 1-minute half-life temperature that is the range of the melt kneading temperature to a temperature about 20° C. higher than this, and specifically that having a 1-minute half-life temperature of 80 to 270° C., is ideal.

By jointly using component (e) and organic peroxides, a radical is formed on the molecular chain of component (a), and by this radical reacting with component (e), the reaction between component (a) and/or component (b) and component (d) is considered to be promoted. The amount of organic peroxide used at this time is ideally 0.01 to 2.0 parts by weight, and more preferably 0.01 to 0.5 parts by weight, relative to 100 parts by weight of component (a).

However, when using natural rubber, isoprene rubber, styrene-isoprene-styrene block copolymer, ethylene-propylene-diene copolymer and the like in component (b), the organic peroxide is not necessarily used. In these rubbers, organic peroxide is not necessarily used since it is considered that cleaving occurs in the molecule in the main chain from a mechanochemical reaction during kneading, whereby —COO group is generated at an end of the main chain, creating a peroxide, which functions equally to an organic peroxide.

In addition, despite the amount of organic peroxide used being a range of 0.01 to 2.0 parts by weight, if it is outside the range at no more than 0.01 parts by weight, the promotion of the reaction will be remarkably inferior, which is not preferable. In addition, when it increases to 2.0 parts by weight or more, the reaction between independent or respective components such as component (a), component (b) and component (d) will be excessively promoted, cross-linking progresses remarkably due to reaction in unmixed components or between respective components, and a gelated (agglomerated) state is entered, and thus the production of the fiber-reinforced thermoplastic resin composition will become difficult.

A matrix composed of component (a), component (b) and component (c) is formed in the composition of the present invention. This matrix may adopt a structure in which component (b) is dispersed in islands in component (a) and component (c), and conversely may adopt a structure in which component (a) is dispersed in islands in component (b) and component (c). Then, it is preferable for mutual bonding between the three components of component (a), component (b), and component (c).

Almost all of component (d) disperses in the above matrix as ultrafine fiber. More specifically, 80% by weight, and preferably at least 90% by weight, disperses as ultrafine fibers. For the fibers of component (d), the average fiber diameter is no more than 1 μm, and more preferably is in the range of 0.01 to 0.8 μm. The aspect ratio is at least 2 and no more than 1000, and more preferably 10 to 500.

Then, component (d) bonds at the interface with any of component (a), component (b) and component (c). The bonding ratio of component (d) with component (a), component (b) and component (c) is in the range of 1 to 30% by weight, and particularly preferably 5 to 25% by weight.

Next, the production process for the fiber-reinforced thermoplastic resin composition will be explained. A matrix adjustment method of a first step is a method of melt kneading component (a), component (b), component (c) and component (e), and a method that performs melt kneading of component (a) with component (e) at a temperature of at least the melting point of component (a), and then melt kneads component (b) and component (c) at a temperature of at least the melting point of component (a) can be exemplified. Melt kneading can be performed using a kneader normally used with resins, rubbers, etc. Examples include a Banbury mixer, kneader, pressure-type kneader, kneader extruder, open rolls, single-screw extruder, twin-screw extruder, etc. Particularly preferable is a twin-screw extruder that can melt knead in a short time and continuously.

The amount of binder is preferably in the range of 0.1 to 20 parts by weight relative to 100 parts by weight of component (a), and more preferably is a range of 0.2 to 15 parts by weight.

As the binder, a silane coupling agent, titanate-based coupling agent, unsaturated carboxylic acid and/or unsaturated carboxylic acid derivative, organic peroxide, silanol group in silica or the like can be exemplified. Silica coupling agents, organic peroxides, silica (silanol group) obtained by the production process of the VMC method, or the like are preferable in the present invention.

Next, the second step will be explained. The second step performing melt kneading of component (d) with the matrix component arrived at by melt kneading component (a), component (b) and component (c) compounding a binder such as component (e) obtained in the first step denatures by way of equipment used in the kneading of resins, rubbers, etc. Specific equipment include a Banbury mixer, kneader, pressure-type kneader, kneader-extruder, open rolls, single-screw extruder, twin-screw extruder, etc. Similarly to the first step, a twin-screw extruder that can melt knead in a short time and continuously is particularly preferable.

For the melt kneading temperature in the second step, melt kneading is done at a temperature of at least the melting point of either component (a) and component (d) to adjust as an extrudate.

If melting and kneading are done at a temperature no higher than the melting point of component (d), then component (d) will not be kneaded and dispersed in the matrix of component (a), component (b) and component (c), and the kneaded product will not be preferable.

The proportion of binder to component (d), when defining a total amount of 100% by weight of component (d) and binder, is 0.1 to 20% by weight, and preferably 0.2 to 15% by weight. When the amount of binder is no more than 0.1% by weight, a strong bond will not be obtained, forming a composition inferior in creep resistance, which is not preferable. On the other hand, when the binder is at least 20% by weight, a majority of component (d) comes to be microscopic spherical shape or egg-shape and have an aspect ratio of no more than 2, and does not form ultrafine fibers. As expected, only a compound inferior in creep resistance could be made.

Next, an explanation of a third step will be provided. The third step draws and/or rolls the above-mentioned extrudate of the second step at a temperature lower than the melting point of component (d), and draws or rolls the kneaded product obtained in the second step from a spinneret, or an inflation die or T-die.

The third step is a step in which fine particles of component (d) in the kneaded product of the second step transform into fibers by spinning and extruding. Therefore, both spinning and extruding must be performed at a temperature of at least the melting point of component (d). More specifically, it is preferably performed at the melting point of component (d), or a range of temperature 20° C. higher than the melting point. In order to form fibers, a drawing process is performed by continuously drawing or rolling the kneaded product to make a stronger fiber. Therefore, drawing and rolling are conducted at a temperature lower than the melting point of component (d).

The third step, for example, is conducted by extruding the kneaded product of the second step from the spinneret of the extruder and spinning into a string shape or filament shape, and winding this with a winder or the like equipped with a bobbin or the like while imposing a draft. Drafting means making the winding speed faster than the extruding speed of the kneaded product coming out from the spinneret of the extruder or the like, and winding.

The draft ratio (draft ratio=(winding speed)/(extrusion speed from spinneret) preferably has a range of 1.5 to 100, and more preferably is a range of 2 to 50.

Additionally, it is possible to continuously roll the extrudate of the second step with a rolling roll, or the like. For example, it can be conducted by winding with a roll or the like while imposing the draft, while extruding the kneaded and extruded product from an inflation die or T die.

In the above-mentioned step, the thermoplastic resin composition forming ultrafine fibers by imposing the draft can be made into various molded product forms such as string shape, filament shape, tape form and pellets.

Next, the operational effects of the present embodiment will be explained.

In the inventions of Japanese Unexamined Patent Application, Publication No. H7-238189 and Japanese Unexamined Patent Application, Publication No. H9-59431, the bond of polyolefin and rubbers with polyamides forms a bond between the interfaces of each via a silicon atom of the silica coupling agent, whereas, in the present embodiment, between the polyolefin, rubbers, silica and polyamide are chemically bonded. More specifically, chemical bonds (hybrid bonds) are established between the respective components by several binder components via two types of coupling agents using a silane coupling agent and silica.

In the first step, compounding is performed by mixing component (a), component (b) and component (C) to make a denatured matrix. On this occasion, denaturing is performed using the silane coupling agent of component (e).

Therefore, at the interface between components of component (a) and component (b) with component (c), (1) the bonding through a silicon atom of the silane coupling agent, and (2) the bonding by the synergy of the silane coupling agent and silica, and bonding by the condensation reaction between silanol groups of silicon dioxide of silica and the silicon atom of the silane coupling agent advances, and it is considered that the chemical bonding at the interface between each component progresses by the two types of bonding of the above-mentioned (1) and (2). Bonding of only one type by silicon atoms of the silane coupling agent as in the technologies of Japanese Unexamined Patent Application, Publication No. H7-238189 and Japanese Unexamined Patent Application, Publication No. H9-59431 differs from the binding mode in the present embodiment covering two types in this way.

Next, in the second step of the present embodiment, melt kneading of component (d) and the denatured matrix obtained in the first step is performed. On this occasion, the denatured matrix component chemically bonds with component (d). The amide groups of component (d) bonds with the alkoxy group of the silane coupling agent in the denatured matrix or silanol group for which a chemical change was induced with moisture.

On the other hand, a silanol group of silica or the like bonds as well. In addition, at the end of compound (d), —COOH or —NH₂ forms, which effectively reacts with this silane coupling agent or the silanol group of silica.

In contrast, despite being a chemical bond by a silane coupling agent in the prior art of Japanese Unexamined Patent Application, Publication No. H7-238189 and Japanese Unexamined Patent Application, Publication No. H9-59431, the present embodiment can provide a fiber-reinforced thermoplastic resin composition having at least two types of binding sites by a single silane coupling agent or via the silanol group of silica, and maintains a more reinforced ultrafine fiber, and a stable production process thereof.

By kneading the thermoplastic resin composition obtained in the present embodiment with a vulcanizable rubber such as natural rubber or synthetic rubber, a fiber-reinforced rubber is formed. In addition, by adding olefin or the like, it is possible to provide modified resins having abrasion resistance, durability, etc.

However, for kneading in this case, it is necessary to knead in a range of a temperature of at least the melting point of component (a) and a temperature of no higher than the melting point of component (d).

Hereinafter, although the present embodiment will be more specifically explained by showing examples and comparative examples, these are not to limit the present invention. In the examples and comparative examples, the measurement methods for the physical properties of the fiber-reinforced thermoplastic resin were as follows.

Scanning electron microscope (SEM) observation: observed with JSM-580LV made by Japan Electro optical Laboratory.

The samples for SEM observation were prepared in the following way. First, with xylene solvent dissolving the polyolefin of component (a) and the rubbery polymer of component (b), the fiber-reinforced thermoplastic resin composition was refluxed in a reflux device such as a Soxhlet, and the polyolefin and rubbery polymer were removed. Next, after performing agitation in 1,2-dichlorobenzene, the remaining silica of component (c) and polyamide of component (d) was left still, floating fibers were recovered, and after further acetone washing the recovered fibers, they were set as samples for SEM observation.

Transmission electron microscope (TEM) observation: observed with H-7100FA made by Hitachi Corporation. A strand obtained in the third step of the embodiment was trimmed and surface shaped with an ultramicrotome, vapor dyeing was conducted by ruthenium (Ru) metallic oxide, and after preparation of ultrathin sections, TEM observation measurement was performed.

Confirmation method for thread breakage during spinning: in the third step of the present embodiment, the kneaded product of the second step was extruded from the spinneret of the extruder and spun into a string shape or filament shape, and this was wound with a winder equipped with a bobbin while imposing a draft, and then state observation during spinning into a string shape or filament shape was confirmed visually.

Average thread diameter: in a scanning electron microscope photograph, horizontal lines were drawn at locations 2 cm from the top and bottom thereof, and the diameter was measured for 400 of the fibers contacting the lines, the average thereof obtained and defined as the average diameter.

Density: measured based on ASTM D1505.

Modulus of elongation: complex modulus of elasticity measured at 23° C. in a Rheovibron DDV-II type (made by Orientec Co., Ltd.).

Tensile strength: measured based on ASTM D638.

Creep resistance: applying a load of 5 MPa on a sample of length L₀, the length L after 1 hour was measured, and using the following formula (I), calculated.

Creep resistance=(L−L₀)/L₀×100 (Formula 1)

Polyamide average fiber diameter: a solvent was selected in accordance with the rubber type, and using a Soxhlet extractor, the rubber and polyolefin in the fiber-reinforced thermoplastic resin composition were extracted and removed, and after further agitating the remaining fiber in a 1,2-dichlorobenzene solvent, was separated into floating fibers precipitating silica, the fibers were recovered and further washed with an acetone solvent, then observed with a scanning electron microscope, and the fiber diameter was measured from an electron microscope image by the same method as the aforementioned “average fiber diameter” to obtain the average diameter thereof.

Binding rate: expressed by numerical values measured by the following method.

A fiber-reinforced thermoplastic resin composition was refluxed in a reflux device such as a Soxhlet with solvents of methylethyl ketone, toluene, xylene, etc. dissolving component (a) and component (b), to remove component (a) and component (b). After carrying out agitation of the remaining component (c) and component (d) in 1,2-dichlorohexane next, and then leaving still, the separation of precipitating silica from the floating fibers was performed, and upon further acetone washing the recovered fibers, the weight was measured after drying, and this weight was defined as Wc.

Then, the proportion Wc/Wco comparing the weight of component (d) in the composition to Wco was obtained, and this was defined as the binding amount.

Next, examples will be explained. Examples 1 to 3 used high density polyethylene (HDPE) “M3800 made by Keiyo Polyethylene, MFR 8 grams/10 min, melting point 125° C., density 0.922 g/c” as component (a), rubbery polymer EPDM “EP-22 made by JSR Corp.” as component (b), “VMC production process silica SO-C2 made by Admatechs Co. Ltd., average particle size 0.5 μm” (hereinafter abbreviated as silica 1) as component (c), and “Ube nylon 1030B made by Ube Industries Ltd., melting point 215-220° C., molecular weight 30,000” as component (d).

First, 100 parts by weight of component (a), 100 parts by weight of component (b), and 40 parts by weight of component (c), 1 part by weight of γ-methacryloxypropyltrimethoxysilane of component (e) and 0.1 parts by weight of the organic peroxide dicumyl peroxide were kneaded at a temperature of the melting point of component (a) or higher using a Banbury mixer, and after discharging at a discharge temperature of 170° C., pelletizing was performed in a feeder ruder set to at least the melting point temperature of component (a) to obtain a denatured product. This was defined as the matrix component.

Next, component (d) was varied in weight to 50, 100 and 150 parts by weight and kneading with the matrix was performed in a twin-screw extruder set to 240° C., and strand-like product extruded from the nozzle at the leading end of the twin-screw extruder was drawn at 10 times the speed of the strand (string form) leaving from the nozzle at the drawing machine to perform drawing, and then measurement of the physical properties was performed. The results thereof and the materials (components) of each example are shown in Table 1.

Example 4 uses the same materials as Example 3; however, the silica 1 of component (c) was increased in amount from 40 to 80 parts by weight.

Example 5 used the same materials as Examples 1 to 3; however, the silica 1 of component (c) was increased in amount to 100 parts by weight, and nylon 6 of component (d) to 250 parts by weight.

Example 6 was done similarly to Example 3, except for using PP “polypropylene J704UG made by Prime Polymer, MFR 5 grams/10 min” as component (a).

For Example 7, the matrix adjustment method and kneading by a twin-screw extruder were performed similarly to Example 3, except for using HNBR “zetpol2020L made by neon Corporation, Mooney viscosity median 57.5” as component (b). The draft ratio was set to 5.

For Example 8, amounts were drastically increased with HNBR of component (b) to 500 parts by weight, silica 1 of component (c) to 200 parts by weight, and component (d) to 350 parts by weight. In addition, except for 10 parts by weight of binder, and increasing the amounts of γ-methacryloxypropyltrimethoxysilane of component (e) to 1 part by weight and organic peroxide dicumyl peroxide to 0.3 parts by weight in 10 parts by weight of binder, it was done similarly to Example 7.

Example 9 was done similarly to Example 3, except for setting high density polyethylene as component (a), and 150 parts by weight of natural rubber as component (b). Natural rubber SMR-L was used as the natural rubber (NR).

Example 10 was done similarly to Example 4, except for using LDPE “F522 made by Ube Maruzen Polyurethane, MFR 5 g/10 min” as component (a).

Next, comparative examples will be explained. Comparative Example 1 was done similarly to Example 1, except for not using the silica of component (c).

Comparative Example 2 was done similarly to Example 1, except for using 40 parts by weight of the silica “Nipsil VN3 made by Tosoh Corporation, precipitation manufacturing process, silica secondary aggregated structure” (hereinafter abbreviated as silica 2) of component (c). The moisture amounts of silica 2 used in the present comparison are all close to 5000 ppm or higher.

Comparative Example 3 set the silica 2 of Comparative Example 2 to 80 parts by weight.

Comparative Example 4 was done similarly to Comparative Example 2, except for using 40 parts by weight of “MSR-8030 made by Tatsumori Ltd., average particle size 11 μm” (hereinafter abbreviated as silica 3) as the silica of component (c).

TABLE 1
Table 1 Examples and Comparative Examples

| | | | Comparative example | | | | Example | | | |
|---|---|---|---|---|---|---|---|---|---|---|
| Component Weight | | | 1 | 2 | 3 | 4 | 1 | 2 | 3 | 4 |
| Component | Component | HDPE | 100 | 100 | 100 | 100 | 100 | 100 | 100 | 100 |
| | (a) | LDPE | — | — | — | — | — | — | — | — |
| | | PP | — | — | — | — | — | — | — | — |
| | Component | EPDM | 100 | 100 | 100 | 100 | 100 | 100 | 100 | 100 |
| | (b) | HNBR | — | — | — | — | — | — | — | — |
| | | NR | — | — | — | — | — | — | — | — |
| | Component | Silica 1 | — | — | — | — | 40 | 40 | 40 | 80 |
| | (c) | Silica 2 | — | 40 | 80 | — | | | | |
| | | Silica 3 | — | — | — | 40 | | | | |
| | Component | Nylon6 | 50 | 100 | 100 | 100 | 50 | 100 | 150 | 150 |
| | (d) | | | | | | | | | |

| | | | | | | | | | |
|---|---|---|---|---|---|---|---|---|---|
| Fiber | Draft ratio | 10 | 10 | Not | 10 | 10 | 10 | 10 | 10 |
| | | | | imposed | | | | | |
| | Thread breakage | None | Frequent | Spinning | Frequent | None | None | None | None |
| | during spinning | | break | not | break | | | | |
| | | | occurrence | possible | occurrence | | | | |
| | SEM observation | Ultrafine | Thick film | — | Thick/thin | Ultrafine | Ultrafine | Ultrafine | Ultrafine |
| | photograph | | | | mixture | | | | |
| | Average fiber | 0.4 | 7 | — | — | 0.2 | 0.3 | 0.4 | 0.2 |
| | diameter μm | | | | | | | | |
| Physical | Density g/cc | 0.964 | 0.976 | — | 0.977 | 0.999 | 1.034 | 1.025 | 1.079 |
| property | Modulus of | 287 | — | — | — | 488 | 524 | 588 | 760 |
| evaluation | elongation Mpa | | | | | | | | |
| | Tensile strength Mpa | 12 | 3.6 | — | 2.5 | 16 | 23 | 26 | 30 |
| | Creep resistance % | 14 | Destroyed | — | Destroyed | 3 | 3 | 2 | 1 |
| | Binding rate % | 8 | — | — | — | 14 | 13 | 11 | 21 |

Example

| Component Weight | | | 5 | 6 | 7 | 8 | 9 | 10 |
|---|---|---|---|---|---|---|---|---|
| Component | Component | HDPE | 100 | — | 100 | 100 | 100 | — |
| | (a) | LDPE | — | — | — | — | — | 100 |
| | | PP | — | 100 | — | — | — | — |
| | Component | EPDM | 500 | 100 | — | — | — | — |
| | (b) | HNBR | — | — | 100 | 500 | — | — |
| | | NR | — | — | — | — | 150 | 150 |
| | Component | Silica 1 | 100 | 40 | 40 | 200 | 40 | 80 |
| | (c) | Silica 2 | | | | | | |
| | | Silica 3 | | | | | | |
| | Component | Nylon6 | 250 | 150 | 150 | 350 | 150 | 150 |
| | (d) | | | | | | | |

| | | | | | | | |
|---|---|---|---|---|---|---|---|
| Fiber | Draft ratio | 10 | 10 | 5 | 5 | 10 | 10 |
| | Thread breakage | None | None | None | None | None | None |
| | during spinning | | | | | | |
| | SEM observation | Ultrafine | Ultrafine | Ultrafine | Ultrafine | Ultrafine | Ultrafine |
| | photograph | | | | | | |
| | Average fiber | 0.3 | 0.4 | 0.3 | 0.4 | 0.2 | 0.2 |
| | diameter μm | | | | | | |
| Physical | Density g/cc | 0.988 | 1.012 | 1.07 | 1.118 | 1.015 | 1.07 |
| property | Modulus of | 355 | 784 | 509 | 508 | 678 | 329 |
| evaluation | elongation Mpa | | | | | | |
| | Tensile strength Mpa | 24 | 25 | 25 | 21 | 27 | 22 |
| | Creep resistance % | 11 | 2 | 2 | 13 | 7 | 8 |
| | Binding rate % | 19 | — | — | — | — | — |

A comparison between the examples and the comparative examples will be explained.

As is clear from Table 1, present Examples 1 to 10 have, in the field of physical property evaluation, a modulus of elongation of 329 to 784, a tensile strength of 16 to 30, and a creep resistance of 1 to 13, and thus excel in rigidity and strength compared to Comparative Examples 1 to 4.

In addition, for Examples 1 to 10, there was no thread breakage when spinning, and were all ultrafine fibers in SEM observation photographic observation, and the average thread diameter was 0.2 to 0.4 μm.

In contrast, for Comparative Example 1 into which silica was not mixed, the modulus of elongation was 287, the tensile strength was 12, the creep resistance was 14, which were worse Examples 1 to 10. This is considered to be due to the binding rate being low compared to present Examples 1 to 10.

Thread breakage during spinning frequently occurred for Comparative Example 2 into which silica 2 was not mixed. This is because the moisture amounts of the silica 2 used are all near 5000 ppm or higher. In addition, upon SEM observation of the nylon of the obtained strand, it was a film.

Comparative Example 3 in which 80 parts by weight of silica 2 was used repeatedly free fell upon draw spinning, and thus spinning was not possible.

In Comparative Example 4, although silica 3 having an average particle diameter of 11 μm was used, it became a foreign substance due to the particle diameter of silica 3 being large, and thus thread breakage often occurred upon spinning in the drawing process of the third step. In addition, upon SEM observation of the nylon of the obtained strands, they were a wide range of fibers of 0.1 μm to 4 μm and fiber shapes were fibers of rough irregular string shape.

In other words, even in the case of using silica, silica forming a secondary aggregate of high water absorbency could not obtain the fiber-reinforced thermoplastic resin composition of Examples 1 to 10.

Next, electron microscope photographs will be explained.

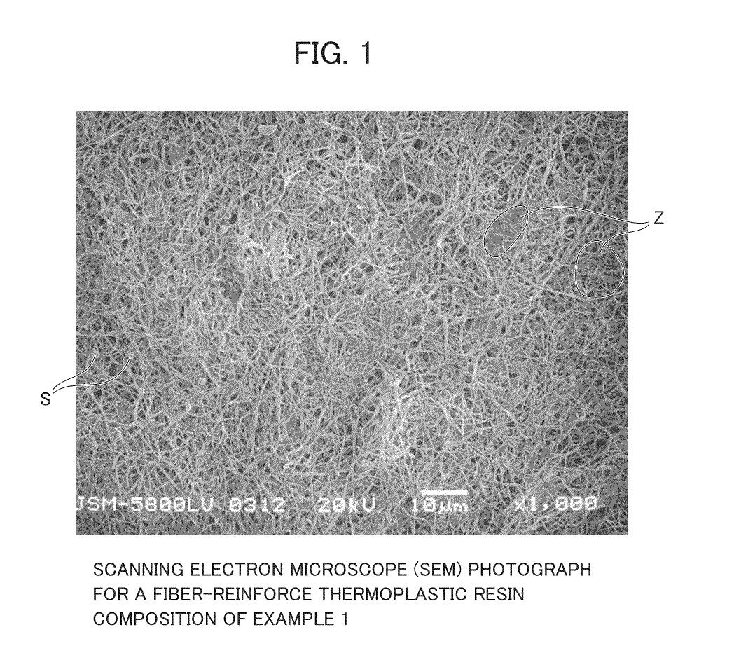

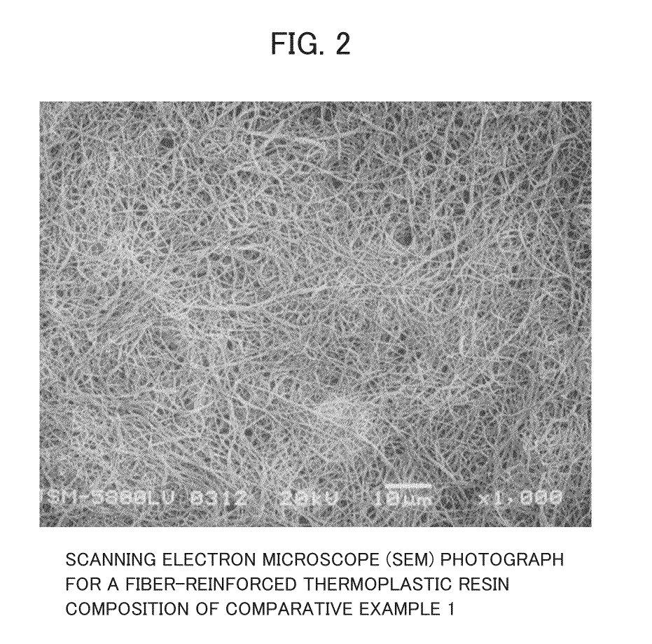

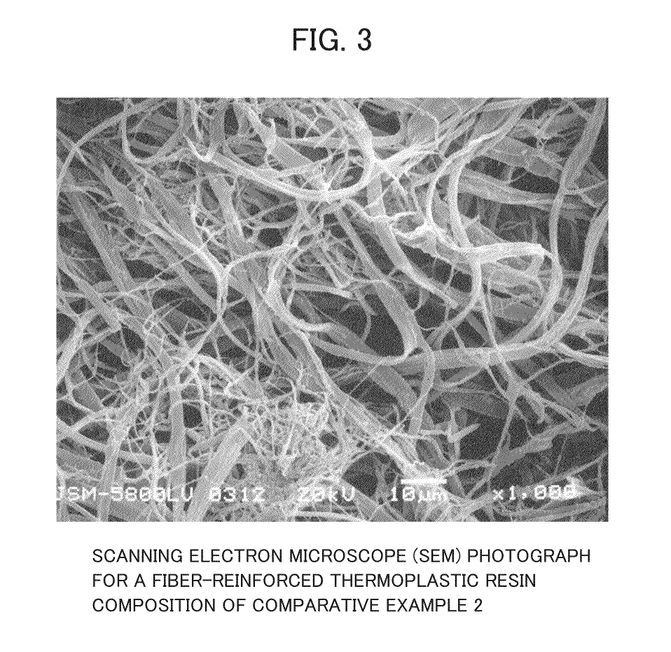

FIGS. 1 to 3 are figures of scanning electron microscope (SEM) photographs, FIG. 1 being a figure of an SEM photograph for Example 1, FIG. 2 for Comparative Example 1, and FIG. 3 for Comparative Example 2.

These photographs are electron microscope photographs observing the morphology of floating fibers, after dissolving high density polyethylene of component (a) and EPDM of component (b) from respective fiber-reinforced thermoplastic resin compositions of Example 1, Comparative Example 1 and Comparative Example 2 in a hot xylene solvent, recovering the polyamide (nylon) fibers of component (d) and residue of silica, strongly agitating in 1,2-dichlorobenzene solution, and leaving to rest.

As is evident from FIG. 2, only ultrafine nylon fibers are observed in Comparative Example 1.

As is evident from FIG. 3, Comparative Example 2 was observed as a film in which the nylon of component (d) underwent hydrolysis with the moisture in the silica upon melt kneading reaction in the second step, without forming an ultrafine fiber morphology, and thus ultrafine does not become the morphology of the fiber-reinforced thermoplastic resin.

In contrast, as is evident from FIG. 1, Example 1 was observed as ultrafine nylon fibers and silica S adhering to the fibrous form thereof. Although strongly agitated and the silica was separated and removed, the adherence of silica S could be confirmed in the figure of the electron microscope photograph. In addition, residue Z of rubbery material of EPDM adhering could also be confirmed. For the residual Z of the rubbery material, the rubber part having reacted with nylon is denatured, and it is considered that the rubbery material Z was observed due to dissolution of EPDM in hot xylene, which is a good solvent, is difficult.

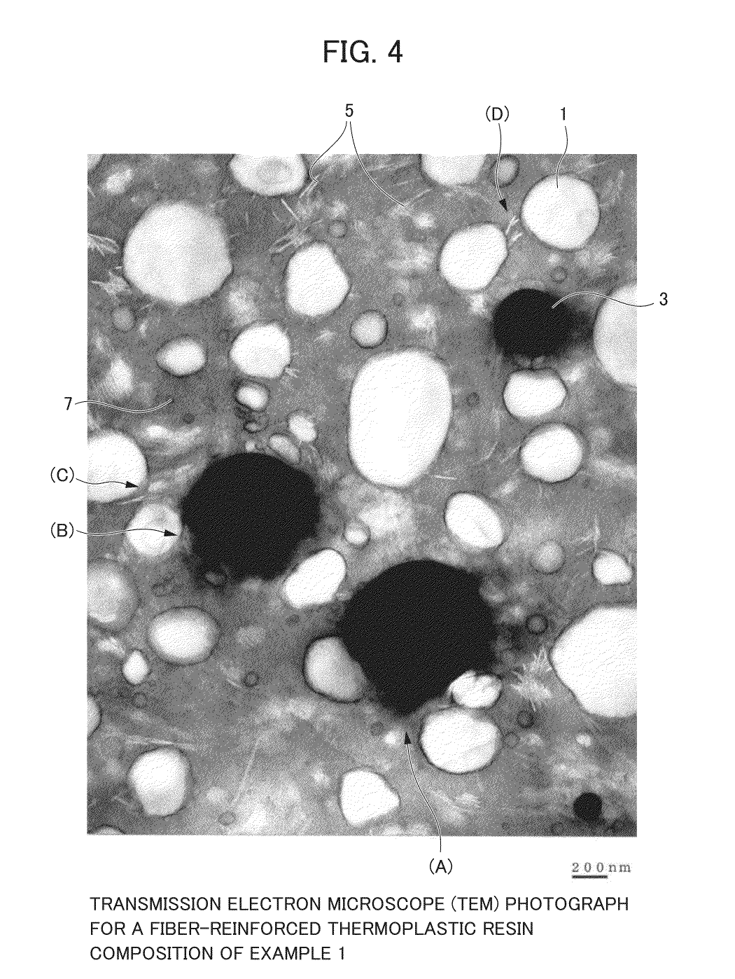

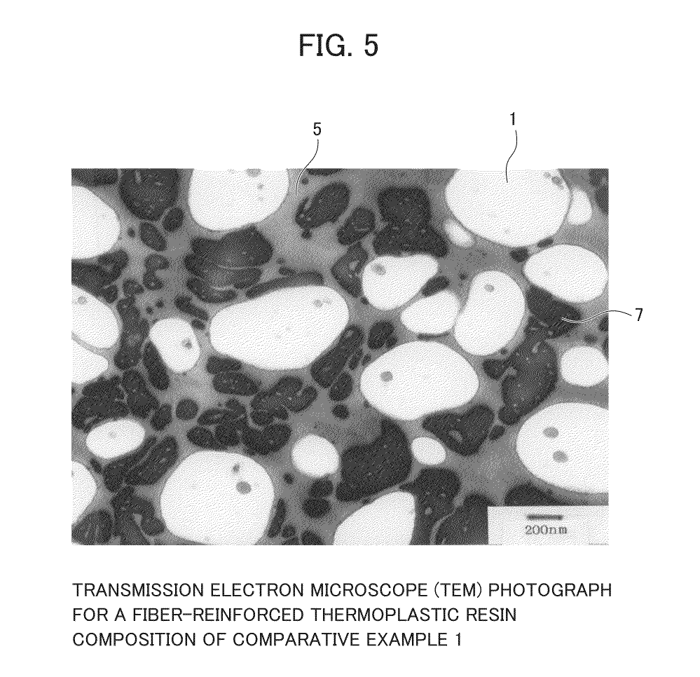

FIGS. 4 and 5 are figures of transmission electron microscope (TEM) photographs, with FIG. 4 being a figure of the TEM photograph for Example 1 and FIG. 5 for Comparative Example 1.

In these FIGS. 4 and 5, the white sphere 1 is a nylon fiber section, the black sphere 3 is silica, the grey irregular shapes 5 are polyethylene, and the black irregular shape 7 is EPDM. It should be noted that the silica 3 is not mixed into Comparative Example 1.

In Comparative Example 1 shown in FIG. 5, the polyethylene 5 of the grey irregular shape and the EPDM 7 of the black irregular shape exist as a matrix at the interface of the nylon fiber 1 (section) of the white sphere. For the interfaces of nylon fiber 1 with both the EPDM 7 and the polyethylene 5 of the matrix component, the interactions between interfaces (compatibility, bonding strength) are weak; therefore, it is observed in a structural form in which between interfaces are distinct.

On the other hand, for Example 1, the interfaces between the polyethylene (white irregular shape, white needles) 5 and EPDM (grey irregular shape) 7 of the matrix component clearly do not separate, and appear blurry.

This means that the interaction has been made strong compared to Comparative Example 1.

Furthermore, the following matters could be observed from FIG. 4.

(1) Coupling between the nylon fibers 1 via the silica (black spheres) 3 was observed, and exhibited strong interactions of “nylon fiber/silica/nylon fiber” (illustrated by (A) in FIG. 4).

(2) A structure in which between nylon fibers 1, 1 and silica 3 directly contact could be confirmed. In addition, between silica and nylon fibers coupled through polyethylene (white needle; PE crystalline lamella), exhibiting interactions of “silica/nylon fiber” and “silica/polyethylene/nylon fiber”, respectively (illustrated by (B) in FIG. 4).

(3) EPDM 7 of the matrix surrounds around the interface of the spheres of silica 3, and the interaction is strong without the interface thereof clearly separating.

(4) Lamella of polyethylene 5 existed in needle-shape from the interface of the spheres of silica 3 towards the matrix, and a reinforcing effect is present as an anchoring effect (illustrated by (C) in FIG. 4). In the anchoring effect, the needle-like polyethylene has several projections, and act as an anchor to the matrix.

(5) Furthermore, the polyethylene 5 interposing between nylon fibers 1, 1, and coupling is observed (illustrated by (D) in FIG. 4).

(6) A structure is made such that the polyethylene 5 in the component of the matrix hits the anchor as a lamella of needle-shape, and an anchoring effect can be expected.

Although the characteristics of the embodiments have been explained in the above-mentioned items (1) to (6) for the TEM photograph of Example 1 shown in FIG. 4, it is clear that these characteristics greatly differ from Comparative Example 1 shown in FIG. 5.

As stated above, based on the structural form in TEM observation, for the fiber-reinforced thermoplastic resin using silica, a strong interaction such as coupling and anchoring effects are realized. For this reason, improvements in durability such as for abrasion and fatigue, mechanical properties such as high elasticity and high tear strength, linear expansion, and the like are possible. These contribute to thinning, weight savings, or advancements in productivity such as dimensional stability.

1. A fiber-reinforced thermoplastic resin composition comprising (a) 100 parts by weight of polyolefin; (b) 10 to 600 parts by weight of rubbery polymer having a glass transition temperature no higher than 0° C.; (c) 10 to 500 parts by weight of spherical silica having an average particle size of no more than 1 μm and a water content of no more than 1000 ppm; (d) 1 to 400 parts by weight of ultrafine fibers of a thermoplastic polymer having amide groups in the main chain; and (e) 0.1 to 20 parts by weight of a silane coupling agent,
wherein component (d) is dispersed as ultrafine fibers having an average diameter of no more than 1 μm in a matrix comprising component (a), component (b) and component (c), and each component among (a), component (b), component (c) and component (d) makes a chemical bond via component (e).

2. The fiber-reinforced thermoplastic resin composition according to claim 1, wherein the fiber diameter of the thermoplastic polymer having amide groups in the main chain of component (d) dispersed in fiber form is no more than 1 μm, and an aspect ratio is at least 2 and no more than 1000.

3. A process for producing a fiber-reinforced thermoplastic resin composition comprising:
a first step of adjusting a matrix component made by melt kneading a polyolefin of component (a) and a rubbery polymer of component (b) having a glass transition temperature of no higher than 0° C., with a silica of component (c) having an average particle size of no more than 1 μm and a water content of no more than 1000 ppm and silane coupling agent of component (e) at the melting point of component (a) or higher; or melt kneading component (a) treated with component (e), component (b) and component (c) at the melting temperature of component (a) or higher; or melt kneading component (a) treated with component (e), component (b) and component (c) at the melting point of component (a) or higher; or melt kneading component (c) treated with component (e), component (a), component (b) and component (c) at the melting point of component (a);
a second step of melt kneading the matrix component and the thermoplastic polymer of component (d) having amide groups in the main chain by a temperature of at least the melting point of both of component (a) and component (d), performing extrusion and adjusting an extrudate; and
a third step of drawing and/or rolling the extrudate at a temperature lower than the melting point of component (d).

4. The process for producing a fiber-reinforced thermoplastic resin composition according to claim 3, using 100 parts by weight of component (a), 10 to 600 parts by weight of component (b), 10 to 500 parts by weight of component (c), and 1 to 400 parts by weight of component (d).

5. The process for producing a fiber-reinforced thermoplastic resin composition according to claim 3, wherein component (a) has a Vicat softening temperature of at least 50° C., or a melting point of 70 to 250° C.

6. The process for producing a fiber-reinforced thermoplastic resin composition according to claim 3, wherein component (d) has a melting point in the range of 130 to 350° C.

7. The process for producing a fiber-reinforced thermoplastic resin composition according to claim 3, wherein component (c) is spherical.
